(19) United States
(12) Patent Application Publication
(10) Pub. No.: US 2019/0090683 A1
(43) Pub. Date: Mar. 28, 2019

(54) DEVICE FOR PREPARING A FILTERED COFFEE BEVERAGE

(71) Applicant: Manfred Hermsen, Bremen (DE)

(72) Inventor: Manfred Hermsen, Bremen (DE)

(21) Appl. No.: 15/933,746

(22) Filed: Mar. 23, 2018

(30) Foreign Application Priority Data
Mar. 27, 2017 (DE) 102017002943.1

(51) Int. Cl. A47J 31/20; A47G 19/14; A47J 31/06

(52) U.S. Cl. CPC A47J 31/20; A47J 31/06; A47G 19/14

(57) ABSTRACT

A device for preparing a filtered coffee beverage is composed of a filter pot and a coffee container. In the starting position, the suitably dimensioned filter pot is situated inside the coffee container and supported on the bottom wall of the latter. In this position, boiling water is poured into the filter pot, and then ground roasted coffee is added, which is mixed with the water by stirring or by means of shaking the device. Thereafter, the filter pot is moved to an upper filtering position, in which the coffee beverage passes through a filter screen at the bottom of the filter pot into the coffee container.

### CROSS-REFERENCE TO RELATED APPLICATIONS

This patent application claims priority on and the benefit of German Patent Application No. 10 2017 002 943.1 having a filing date of 27 Mar. 2017.

### BACKGROUND OF THE INVENTION

### Technical Field

The invention relates to the manual preparation of a filtered coffee beverage with the aid of a device for manually producing a filtered coffee beverage with a collecting container, hereinafter coffee container, and with a receiving receptacle for water and coffee, hereinafter filter pot, which in the bottom region has a fine-mesh screen fabric made of metal or plastic, hereinafter filter screen, which separates the aqueous coffee extract from the undissolved solid fraction.

### Prior Art

A drink of coffee is in principle prepared by bringing ground coffee into contact with hot or boiling water. In the manual preparation method (which is the method in question here), the water with the dissolved solids of the coffee is separated from the undissolved solid fraction (coffee grounds) generally with the aid of paper as a filter, with the advantage that an extremely clear beverage can be produced, but with the disadvantage that paper is not taste neutral and has to be supplied again time after time. It is for this reason that (permanent) filters made of stainless steel or plastic are frequently used, although their pores are often not sufficiently fine to obtain a clear beverage comparable to that produced with the paper filter, or their pores are so fine that they easily become clogged and are difficult to clean. A solution to this problem has been proposed with the filter device according to DE 2207839, although said filter device has certain disadvantages in terms of its design and its use, which disadvantages are avoided by the device according to the invention.

### BRIEF SUMMARY OF THE INVENTION

The object of the invention is to improve the preparation of a filtered coffee beverage with the aid of a novel design of the preparation device (filter device), and by means of a simple and practical method of preparation (of quite small and also quite large amounts per preparation) in such a way as to permit the production of a beverage that is of particularly high quality in terms of taste and aroma.

This object is achieved by the device according to the for manually producing a filtered coffee beverage with a collecting container, hereinafter coffee container, and with a receiving receptacle for water and coffee, hereinafter filter pot, which in the bottom region has a fine-mesh screen fabric made of metal or plastic, hereinafter filter screen, which separates the aqueous coffee extract from the undissolved solid fraction, characterized by the following features:
a) the filter pot is arranged inside the coffee container and is movable in the longitudinal direction inside the coffee container,
b) the filter pot, in its starting position, is supported on a bottom wall of the coffee container and serves to receive the boiling water and the ground coffee which is dispersed in the heated water by stirring or by means of shaking the filter device, and
c) the filter pot is lifted to the filtering position, such that the coffee beverage, i.e. the water saturated with the water-soluble solid fractions of the coffee, runs into the coffee container.

The device according to the invention is basically composed of two containers, namely a collecting vessel for water and coffee, hereinafter designated as filter pot, and a container for the finished beverage, hereinafter designated as coffee container. In the starting position, the filter pot, on account of its suitable size and shape, is arranged (almost) completely inside the coffee container. In the bottom region of the filter pot there is a filter designed as a screen fabric made of metal (stainless steel) or plastic, preferably in the configuration as a filter base of the filter pot. In this starting position, the filter pot is sealed off in relation to the coffee container, preferably by the filter pot being supported under a pressure load on the bottom of the coffee container.

In the preparation of the coffee beverage, the procedure according to the invention is that boiling water is first of all introduced into the filter pot, wherein the water is retained in the filter pot on account of the filter pot bearing with a sealing action on the bottom of the coffee container. A dosed quantity of ground coffee is then added to the heated water and stirred into the latter or, in the case of smaller quantities of water and coffee, dispersed by means of shaking the filter device. The coffee solids that are water-soluble at ca. 100° Celsius are gently released from the coffee.

In a further step for producing the finished coffee beverage, the filter pot inside the coffee container is brought from the starting position to a filtering position. For this purpose, the filter pot inside the coffee container is moved upward to an upper filtering position. The coffee beverage runs through the filter screen into the coffee container. In both functional positions, namely in the starting position at the bottom of the coffee container and in the upper filtering position, the filter pot is fixable by mechanical coupling members, wherein the latter are fixed and released by rotation movement of the filter pot relative to the coffee container.

The interacting containers (filter pot and coffee container) are separable from each other, in particular for the purpose of emptying and cleaning the filter pot including filter screen, by rinsing preferably with hot water from the outside (i.e. the underside of the filter screen) and from the inside.

### BRIEF DESCRIPTION OF THE DRAWINGS

Further details and features of the invention are explained below with reference to the drawings, in which:

FIG. 1 shows the device for preparing a filtered coffee beverage in the starting position, in vertical cross section;

FIG. 2 shows a view of the device in the filtering position, likewise in vertical cross section;

FIG. 3 shows the position of the device according to FIG. 2 in a side view;

FIG. 4 shows an anchoring ring on the coffee container in axial cross section; and

FIG. 5 shows the anchoring ring in transverse or horizontal cross section.

### DETAILED DESCRIPTION OF PREFERRED EMBODIMENTS

The device is composed of two containers or receptacles with different functions.

These are a filter pot 10 and a collecting container for the finished beverage, hereinafter coffee container 11. Filter pot 10 and coffee container 11 are adapted to each other in terms of size and shape. The (cylindrical) filter pot 10 is arranged inside the likewise cylindrical coffee container 11, the filter pot 10 being of smaller diameter.

The filter pot 10 consists of a wall 12 of metal, glass or preferably plastic. The filter pot 10 is open at the top. At the underside, the container bottom is formed by a filter screen 13 which preferably occupies the entire bottom surface of the filter pot 10. The filter screen 13 is designed as a permanent filter and consists of a narrow-mesh fabric (e.g. 5μ) of stainless steel or plastic. The filter screen 13 is connected releasably as an autonomous component to the filter pot 10. For this purpose, the filter screen 13 is bordered by a threaded ring made of plastic, via which the filter screen 13 is connected to the filter pot 10, which likewise has a thread in the lower region.

The coffee container 11 as outer container with an outer wall 14 is likewise open at the top. A bottom wall 15 forms a lower closure of the coffee container 11. The latter can also be made of metal, glass or plastic (or a combination of these materials).

The filter pot 10 is arranged concentrically inside the coffee container 11. In the starting position, the filter pot 10 is supported on the bottom wall 15 of the coffee container 11, specifically with sealing contact pressure.

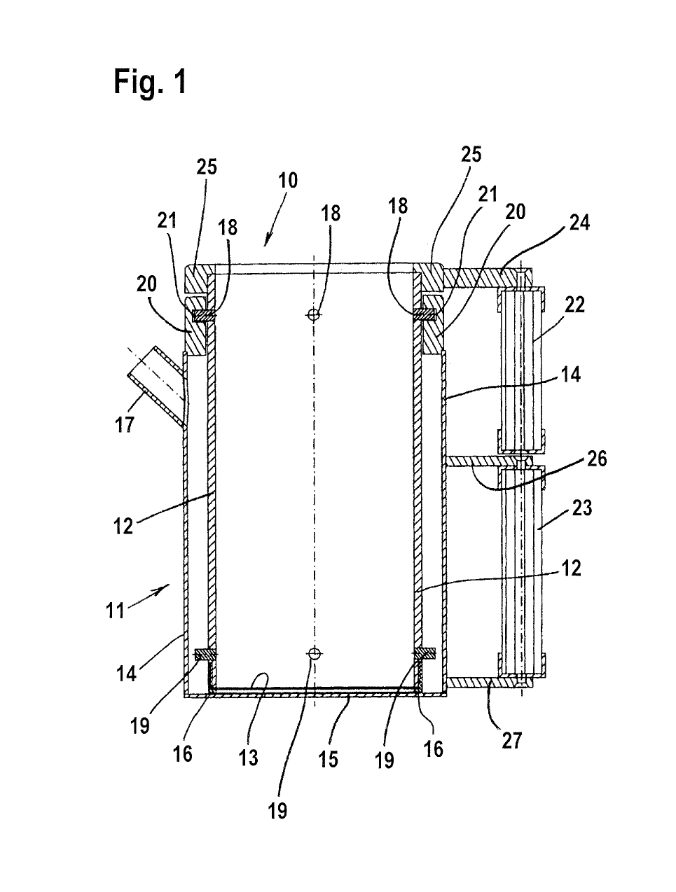

For preparation of the coffee beverage in the starting position according to FIG. 1, using the procedure that can be implemented by the device, preferably boiling water is first of all poured into the filter pot 10 in a manner adapted to the desired strength and quantity of the coffee beverage that is to be produced. A similarly adapted amount of ground roasted coffee is then added to the water and stirred into the latter or, in the case of smaller amounts of water and ground coffee, is mixed in by means of shaking the filter device. The strength of the coffee beverage can also be influenced by different brew times or contact times.

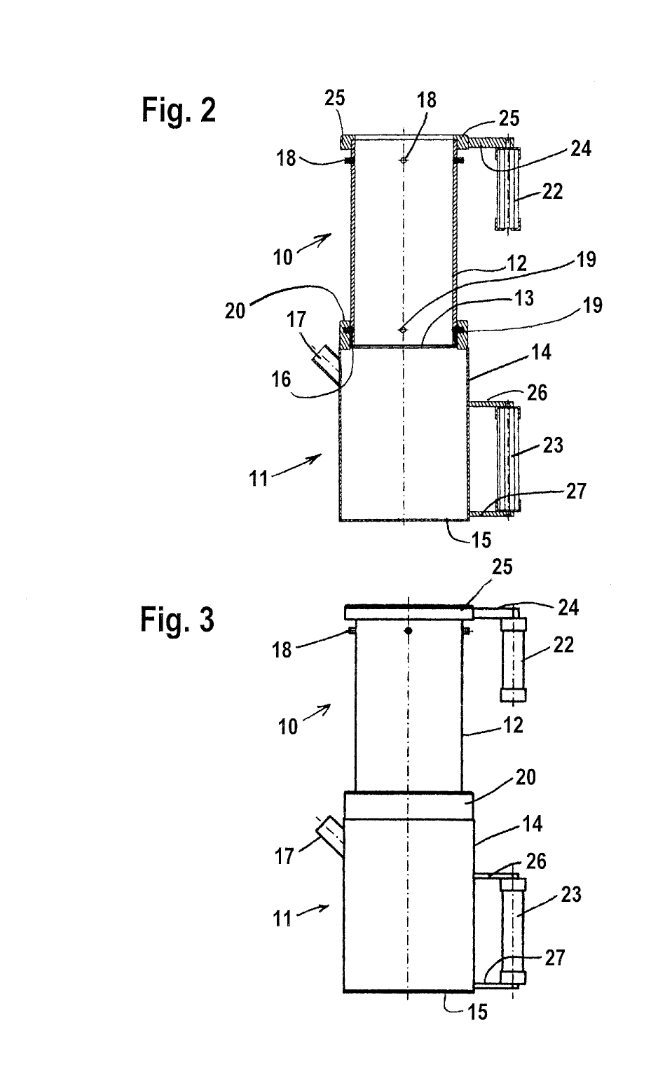

The filtering process is initiated by lifting the filter pot 10 to the filtering position according to FIG. 2. The coffee beverage now passes through the filter screen 13 into the coffee container 11. The coffee grounds are retained on the filter screen 13. The finished coffee beverage in the coffee container 11 can be transferred into another container or coffeepot or can be poured directly into drinking vessels. For this purpose, the coffee container 11 is provided with a spout 17 for pouring out the coffee beverage.

The device is designed such that the filter pot 10 adopts two fixable positions inside the coffee container 11, namely the starting position according to FIG. 1 and the filtering position according to FIG. 2 and FIG. 3. In addition, the filter pot 10 can be detached completely from the coffee container 11 in order to empty and clean the filter pot 10, including filter screen 13, by rinsing with preferably warm or hot water from the outside and inside.

The filter pot 10 and the coffee container 11 are fixed in the end positions by mechanical locks. In the present case, radially oriented anchoring pins 18, 19 are arranged on the outside of the filter pot 10, specifically adjacent to the lower edge, on the one hand, and also to the upper edge, on the other hand, of the filter pot 10. The upper anchoring pins 18 fix the filter pot 10 in the starting position according to FIG. 1, preferably in such a way that the filter pot 10 is supported with a certain pressure on the bottom wall 15. The lower anchoring pins 19 effect the locking of the filter pot 10 in the filtering position according to FIG. 2.

The example is so configured that four radially oriented anchoring pins 18, 19 are in each case distributed along the circumference of the filter pot 10. These anchoring pins 18, 19 interact with anchoring pieces on the coffee container 11, in the present case with an anchoring ring 20 which runs all the way round and which is mounted at the upper end or at the upper end region of the wall of the coffee container 11, namely on the outer wall 14. The anchoring ring 20 formed with corresponding dimensions is offset inwardly by the thickness of the wall, in such a way that the filter pot 10 of smaller diameter is enclosed tightly, i.e. with little spacing, by the anchoring ring 20.

The anchoring ring 20 is provided on the inside with grooves 21 into which the anchoring pins 18, 19 engage depending on the position of the filter pot 10. The grooves 21 assigned to each pin 18, 19 are arranged such that the anchoring of the filter pot 10 in the respective position is effected by its rotation movement relative to the coffee container 11 (bayonet connection). In the starting position according to FIG. 1, the contact pressure for supporting the filter pot 10 on the bottom wall 15 is at the same time generated by the anchoring of the (upper) pins 18 in the anchoring ring 20.

The anchoring of the lower pins 19 in the anchoring ring 20 is configured in a particular way, namely in such a way that, after completion of the filtering process, the filter pot 10 can be detached from the coffee container 11, specifically by a corresponding (further) rotation movement of the filter pot 10, such that the filter pot 10 including filter screen 13 can be emptied and cleaned as described above.

Filter pot 10 and coffee container 11 are provided with handles 22, 23 for gripping and thereby operating the device. The handle 22 assigned to the filter pot 10 is secured by a (single) connecting web 24 to the upper edge of the filter pot 10. This has an anchoring ring 25 which, as an upper end profile of the filter pot 10, is designed as an outwardly oriented projection extending all the way round. The handle 22 or the connecting web 24 is secured thereto.

The handle 23 is mounted on the coffee container 11 via an upper connecting web 26 and a lower connecting web 27, in the present case directly on the container wall 14. Through the arrangement and design of the handles 22, 23, the device can be operated manually in the manner described. The arrangement and size of the handles 22, 23 are chosen such that they do not interfere with each other even in the starting position (FIG. 1).

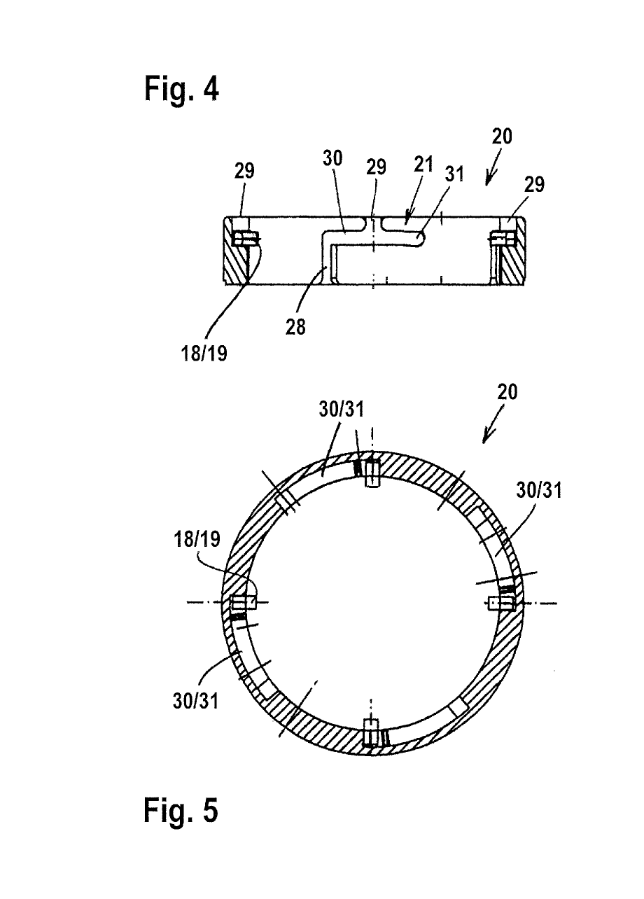

An illustrative embodiment for the anchoring ring 20 located at the upper edge region of the outer container, i.e. of the coffee container 11, is shown in FIG. 4 and FIG. 5. The ring, made preferably of plastic, is provided with the specially configured grooves 21 for anchoring the (four) anchoring pins 18, 19. Each anchoring pin is assigned a groove 21 on the inner side of the anchoring ring 20.

The grooves 21 are chosen such that they permit the anchoring positions of the filter pot 10 inside the coffee container 11, but also the removal of the filter pot 10 from the coffee container 11. Each groove 21 accordingly consists of axially oriented groove limbs 28 and 29 which are open in one or other direction for insertion and disengagement of a pin 18, 19. The groove limbs are connected to each other by an anchoring limb 30 extending in the circumferential direction of the anchoring ring 20. This anchoring limb 30 extends from the groove limb 28 and via the offset groove limb 29 as far as an anchoring end 31.

In the positions in which the filter pot 10 and the coffee container 11 are anchored in each other, i.e. in the position according to FIG. 1 and in the position according to FIG. 2/FIG. 3, the associated anchoring pin 18 or 19 is guided into the groove 21 via the downwardly open groove limb 28 by means of a corresponding relative movement. After the anchoring limb 30 is reached, a corresponding rotation of the filter pot 10 and of the coffee container 11 relative to each other is effected, such that the associated anchoring pin 18 or 19 is guided into the region of the anchoring end 31 of the groove 21. The containers are now fixed in the associated relative position to each other.

When the inner container, i.e. the filter pot 10, is to be brought from the lower starting position (FIG. 1) to the upper filtering position (FIG. 2), the associated (upper) anchoring pin 18 is first of all moved into the region of the upwardly open groove limb 29 by means of a corresponding rotation movement. The associated pin 18 can be moved out of the anchoring via the groove limb 29, and the filter pot 10 can arrive at the upper position. In the latter, the anchoring is then repeated in the described manner with the aid of the lower anchoring pins 19. Likewise the release of the anchoring, when the filter pot 10 is intended to be separated from the coffee container 11, e.g. for the purpose of emptying and cleaning.

### LIST OF REFERENCE NUMBERS

10 filter pot
11 coffee container
12 filter pot wall
13 filter screen
14 coffee container wall
15 bottom wall of the coffee container
16 filter screen edge
17 spout
18 anchoring pin
19 anchoring pin
20 anchoring ring
21 groove
22 handle
23 handle
24 connecting web
25 anchoring ring
26 connecting web
27 connecting web
28 groove limb
29 groove limb
30 anchoring limb
31 anchoring end

What is claimed is:

1. A device for manually producing a filtered coffee beverage with a collecting container, hereinafter coffee container (11), and with a receiving receptacle for water and coffee, hereinafter filter pot (10), which in the bottom region has a fine-mesh screen fabric made of metal or plastic, hereinafter filter screen (13), which separates the aqueous coffee extract from the undissolved solid fraction, wherein:
a) the filter pot (10) is arranged inside the coffee container (11) and is movable in the longitudinal direction inside the coffee container (11);
b) the filter pot (10), in its starting position, is supported on a bottom wall (15) of the coffee container (11) and serves to receive the boiling water and the ground coffee which is dispersed in the heated water by stirring or by means of shaking the filter device; and
c) the filter pot (10) is lifted to the filtering position, such that the coffee beverage, i.e. the water saturated with the water-soluble solid fractions of the coffee, runs into the coffee container (11).

2. The device according to claim 1, wherein the filter pot (10) inside the coffee container (11) is fixable in the starting position on the one hand and in the filtering position on the other hand.

3. The device according to claim 2, wherein the filter pot (10) is fixed releasably in its respective positions inside the coffee container (11) by anchoring elements which interact with form-fit engagement, in particular by anchoring pins (18, 19) on the outside of the filter pot (10) and by mating elements, in particular by anchoring pieces or by an anchoring ring (20) on the inside of an upper, free end region of the side wall (14) of the coffee container (11), wherein the anchoring ring (20) has grooves (21) for the releasable engagement of the anchoring pins (18, 19).

4. The device according to claim 3, wherein the grooves (21) of the anchoring ring (20) are designed and arranged to receive the anchoring pins (19) in the filtering position of the filter pot (10) such that, after completion of the filtering process, the filter pot (10) is releasable from the coffee holder (11) by (further) rotational movement, in particular for emptying and cleaning the filter pot (10) and filter screen (13).

5. The device according to claim 3, wherein the round filter screen (13), in a lower end region of the filter pot (10), is fixed releasably at a short distance from or flush with the container wall (12) of the filter pot (10), in such a way that the filter screen (13) is detachable from the filter pot (10) by actuation of its edge (16) designed as a threaded ring.

6. The device according to claim 1, wherein further comprising handles (22, 23) that are mounted on the filter pot (10) and on the coffee container (11), the handles (22, 23) also serving for carrying out the movements of the filter pot (10) in the longitudinal direction and, by rotation, in the horizontal direction inside the coffee container (11).
